(19) United States
(12) Patent Application Publication
(10) Pub. No.: US 2010/0242657 A1
(43) Pub. Date: Sep. 30, 2010

(54) DUAL CLUTCH TRANSMISSION

(76) Inventors: Masanori SHINTANI, Okazaki-shi (JP); Hiroshi Nozaki, Okazaki-shi (JP)

Correspondence Address: BIRCH STEWART KOLASCH & BIRCH, PO BOX 747, FALLS CHURCH, VA, 22040-0747, US

(21) Appl. No.: 12/722,284

(22) Filed: Mar. 11, 2010

(30) Foreign Application Priority Data
Mar. 27, 2009 (JP) P2009-079537

(51) Int. Cl. F16H 59/02

(52) U.S. Cl. 74/473.24

(57) ABSTRACT

A dual clutch transmission includes: shift rail members having shift lug portions and performing, by actuating shift fork members, a shifting-in operation and a shifting-out operation; a shift select member having an arm portion and, after selecting the shift lug portion of the shift rail member corresponding to a target forward gear stage by moving the arm portion in a select direction, operating the shift rail member by moving the arm portion to perform the shifting-in operation or the shifting-out operation of the target forward gear stage. A movement direction of the arm portion for the shifting-in operation of a higher forward gear stage next higher than one of the forward gear stages except for the highest gear stage and the lowest gear stage is opposite to a movement direction of the arm portion for the shifting-in operation of a lower forward gear stage next lower than the one of the forward gear stages. The arm portion is formed to project so as to simultaneously select the shift lug portions of the shift rail members corresponding to the higher and lower forward gear stages when shifting in the one of the forward gear stages.

### BACKGROUND OF THE INVENTION

The present invention relates to a dual clutch transmission in which a plurality of main shafts provided with a plurality of gear stages are joined to an engine driving force transmission shaft via different clutches.

As a transmission provided in a driving force transmission system of a vehicle, a dual clutch transmission including two clutches installed between the transmission and an engine as a drive source has been proposed as a mechanical automatic transmission without using a torque converter. The dual clutch transmission has first and second main shafts provided with a plurality of gear stages, and each of the main shafts changes the speed of a torque from each clutch and transmits it to an opposed counter shaft, and rotation at the changed speed from the counter shaft is transmitted to the transmission output gear side.

Such a dual clutch transmission of the related art includes a shift fork which shifts the gear stage, a plurality of shift rail members provided with shift lug portions projecting from the surfaces and disposed so that their axes are set in a shift direction, and a shift select member provided with an arm portion which is disposed so that their axes are set in a select direction orthogonal to the shift direction, and projects from the surface and presses the shift lug portions to move these in the shift direction. By moving the shift select member by first drive means to select a gear stage and actuating it in the shift direction by second drive means to press the shift lug portion in the shift direction by the arm portion, a gear shifting operation is performed. As such a dual clutch transmission of the related art, JP-A-2001-304411 is proposed.

As a gear shifting pattern of the dual clutch transmission of the related art, there is available a pre-select pattern in which, during traveling with an arbitrary forward gear stage other than the highest gear stage and the lowest gear stage of the plurality of gear stages, the arm portion is moved to and made to stand by in advance at a select position corresponding to a next gear stage next higher or next lower than the current traveling gear stage (pre-select state), and when a gear shift signal is input, by pressing the shift lug portion by the arm portion by actuating the shift select member by driving the drive means, the gear stage is shifted to the next higher or next lower gear stage, and the clutch joined to an arbitrary gear stage side before gear shifting is disengaged while the clutch joined to the shifted gear stage side is engaged.

In this pre-select pattern, a gear stage to which a driver will perform shifting is estimated in advance and the arm portion is moved to and made to stand by at the next gear stage from the current gear stage, however, in some cases, the gear stage is shifted to a gear stage opposite to the estimated gear stage. For example, when the transmission has first to sixth forward gear stages and the vehicle travels with the fourth gear stage as an arbitrary gear stage, the third or fifth gear stage is the next gear stage. In this case, in actuality, when the gear stage is shifted (shifted up) to the fifth gear stage in a position state in which it is estimated that the gear stage will be shifted (shifted down) to the third gear stage and the arm portion stands by in a select direction corresponding to the shift lug portion of the shift rail member which performs the operation for shifting to the third gear stage, if the third and fifth gear stages are disposed on different shift select members, the shift select member must be moved in the shift direction after being moved in the fifth gear stage select direction, and gear shifting takes time. Even when, in actuality, the gear shifting is not performed, the shift select member is moved in the select direction by the drive means each time estimation of gear stage shift-up or shift-down is changed, so that the moving operation in the select direction based on the estimation becomes pointless, and considering operation noise and the durability of the drive means, there is room for improvement.

### SUMMARY

It is therefore an object of the invention to provide a dual clutch transmission which realizes quick gear shifting up and down operations with low noise and improves the durability of the device.

In order to achieve the object, according to the invention, there is provided a dual clutch transmission in which a plurality of forward gear stages are grouped into first and second groups, first and second main shafts each of which corresponds to the respective one of the first and second groups are provided, and the first and second main shafts are joined to an engine driving force transmission shaft via different clutches, respectively, the dual clutch transmission comprising:

a plurality of shift rail members, each of which has a shift lug portion projecting from a surface thereof, the shift rail members which perform, by actuating shift fork members interlocked by movement of the shift rail members in a shift direction, a shifting-in operation for shifting to a forward gear stage and a shifting-out operation for shifting out of a forward gear stage;

a shift select member which has an arm portion projecting from a surface thereof, the shift select member which, after selecting the shift lug portion of the shift rail member which corresponds to a target forward gear stage by moving the arm portion in a select direction orthogonal to the shift direction, operates the shift rail member having the selected shift lug portion by moving the arm portion in the shift direction to perform the shifting-in operation or the shifting-out operation of the target forward gear stage which corresponds to the shift rail member, wherein

a movement direction of the arm portion for the shifting-in operation of a higher forward gear stage next higher than one of the forward gear stages except for the highest gear stage and the lowest gear stage is opposite to a movement direction of the arm portion for the shifting-in operation of a lower forward gear stage next lower than the one of the forward gear stages, and

the arm portion is formed to project so as to simultaneously select the shift lug portions of the shift rail members which correspond to the higher forward gear stage and the lower forward gear stage when shifting in the one of the forward gear stages.

The shift lug portion may be formed with a columnar portion. The shift select member may be formed with a swing shaft portion which moves the arm portion in the select direction and swings the arm portion in the shift direction. The arm portion may be moved in the select direction to select the shift lug portion and be swung around an axis of the swing shaft portion: by applying a pressing force in the shift direction to the columnar portion of the selected shift lug portion from one side surface, to operate the shift rail member having the shift lug portion to perform the shifting-in operation of the forward gear stage which corresponds to the shift rail member; and by applying a pressing force in the shift direction to the columnar portion of the selected shift lug portion from the other side surface, to operate the shift rail member having the shift lug portion to perform the shifting-out operation of the forward gear stage which corresponds to the shift rail member.

The arm portion may project so as to be forked at an angle to have arm portions between which the shift lug portion is allowed to be disposed. The angle may be set so as to allow the arm portion to move without interference with each shift lug portion at an arbitrary shift position. The arm portion may be moved in the select direction to select the shift lug portion and be swung around the axis of the swing shaft portion of the shift select member: by applying a pressing force in the shift direction from one side surface of the selected shift lug portion by one of the arm portions, to operate the shift rail member having the selected shift lug portion to perform the shifting-in operation of the forward gear stage which corresponds to the shift rail member; and by applying a pressing force in the shift direction from the other side surface of the selected shift lug portion by the other of the arm portions, to operate the shift rail member having the selected shift lug portion to perform the shifting-out operation of the forward gear stage which corresponds to the shift rail member.

One of the shift rail members and another one of the shift rail members may be disposed on the sides opposite to each other across the shift select member, and the shift lug portions of the shift rail members may be extended toward the shift select member.

The dual clutch transmission may further include: inverting means for inverting an actuation direction of the shift fork member interlocked with the shift rail member having the selected shift lug portion with respect to the movement direction of the arm portion which has selected the shift lug portion.

The inverting means may be disposed between one of the shift rail members and the shift fork member, and include an inverting rail member opposed to the one of the shift rail members and supported movably in the shift direction, and a joint arm member which has both ends engaged with the one of the shift rail members and the inverting rail member and which is rotatable around a shaft portion positioned between the both ends.

### BRIEF DESCRIPTION OF THE DRAWINGS

FIG. 1 is a schematic configuration view of a driving force transmission system of a vehicle equipped with a gear shifting operation device of a dual clutch transmission as an embodiment of the present invention;

FIG. 2 is a schematic configuration view two-dimensionally showing the gear shifting operation device of the dual clutch transmission of FIG. 1;

FIG. 3(a), FIG. 3(b), and FIG. 3(c) are enlarged views showing configurations of arm portions and a shift lug portion of the dual clutch transmission;

FIG. 4(a) and FIG. 4(b) are views showing the disposition relationship among the arm portions and the shift lug portions;

FIG. 5 is a view showing another mode of the disposition relationship among the arm portions and the shift lug portions when shifting;

FIG. 6 is a schematic configuration view of a driving force transmission system of a vehicle equipped with a dual clutch transmission as another embodiment of the present invention including inverting means;

FIG. 7 is an enlarged view showing a mode of the inverting means of the dual clutch transmission shown in FIG. 6;

FIG. 8 is a schematic configuration view of a driving force transmission system of a vehicle equipped with a dual clutch transmission as another embodiment of the present invention in which the disposition of the shift rail members is different; and

FIG. 9(a) and FIG. 9(b) are enlarged views showing the disposition of the shift rail members.

### DETAILED DESCRIPTION OF EMBODIMENTS

Hereinafter, embodiments of the present invention will be described with reference to the drawings.

### First Embodiment

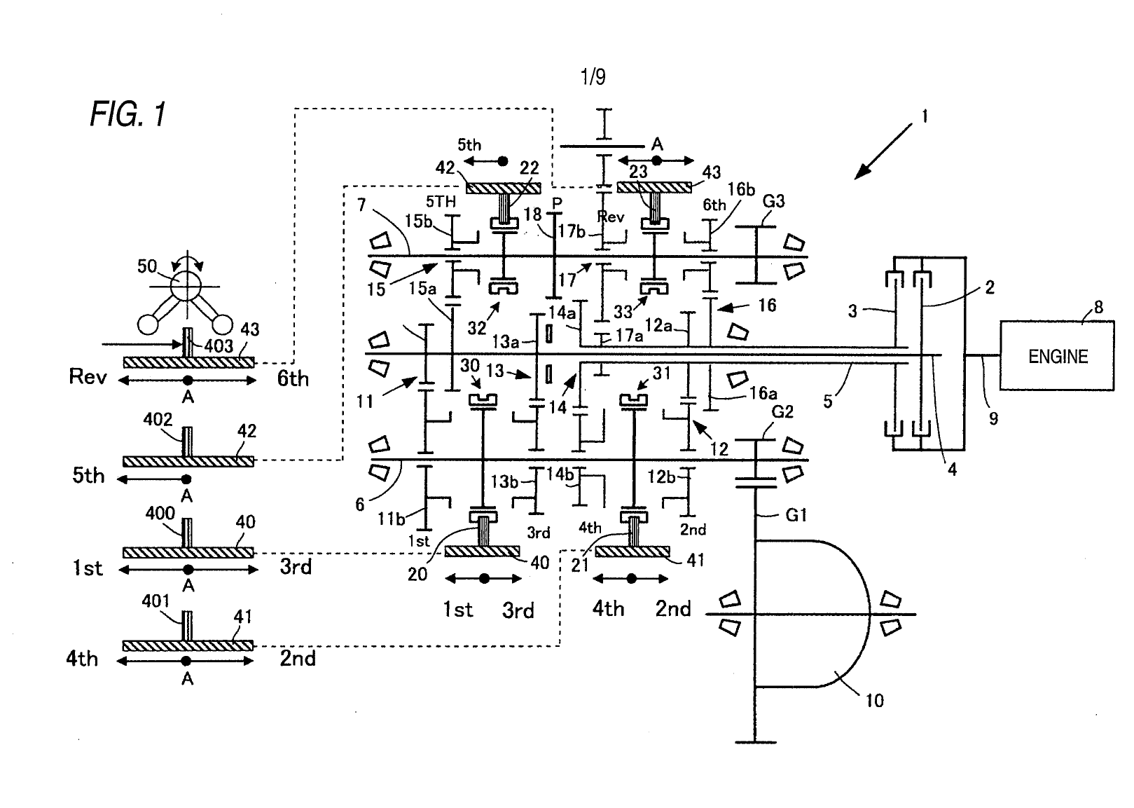

A dual clutch transmission 1 shown in FIG. 1 is a dual-clutch type automatic transmission (hereinafter, referred to as “dual clutch transmission 1”). The dual clutch transmission 1 includes two clutches 2 and 3, two main shafts 4 and 5 disposed on the same axis, and two counter shafts 6 and 7. To the first main shaft 4, a driving force is transmitted by a driving force transmission shaft 9 which transmits a driving force from an engine 8 via the first clutch 2. To the second main shaft 5, a driving force is transmitted by a driving force transmission shaft 9 which transmits a driving force from the engine 8 via the second clutch 3. Engagement and disengagement of the two clutches 2 and 3 are controlled by a control device not shown (for example, a hydraulic, electric, or mechanical control device).

The first counter shaft 6 and the second counter shaft 7 are separated from each other so that the first main shaft 4 and the second main shaft 5 and their axes become parallel. An output gear G2 of the counter shaft 6 and an output gear G3 of the counter shaft 7 are configured to become capable of transmitting power to a reduction gear A1 joined to a differential 10 on the rear stage side of the dual clutch transmission 1.

In the present embodiment, the transmission has six forward gear stages including the initial gear stage (lowest forward gear stage) set as a first-speed gear stage and the final gear stage (highest forward gear stage) set as a sixth-speed gear stage, and a reverse gear stage 17. On the first counter shaft 6, a first-speed idler gear 11b, a second-speed idler gear 12b, a third-speed idler gear 13b, and a fourth-speed idler gear 14b are supported rotatably. On the first counter shaft 6, in order from the output gear G2 side, the second-speed idler gear 12b, the fourth-speed idler gear 14b, the third-speed idler gear 13b, and the first-speed idler gear 11b are aligned.

To the second counter shaft 7, a fifth-speed idler gear 15b, a sixth-speed idler gear 16b, and a reverse idler gear 17b are axially supported rotatably, and a parking gear 18 is fixed. On the second counter shaft 7, in order from the output gear G3 side, the sixth-speed idler gear 16b, the reverse idler gear 17b, the parking gear 18, and the fifth-speed idler gear 15b are aligned.

To the first main shaft 4, a first-speed drive gear 11a, a third-speed drive gear 13a, and a fifth-speed drive gear 15a are joined so as to become capable of transmitting rotations. To the second main shaft 5, a second-speed drive gear 12a, a fourth-speed drive gear 14a, a sixth-speed drive gear 16a, and a reverse drive gear 17a are joined so as to become capable of transmitting rotations.

Each drive gear and each idler gear corresponding to each other are combined to constitute a gear stage. That is, the first-speed drive gear 11a and idler gear 11b constitute the first-speed gear stage 11, the second-speed drive gear 12a and idler gear 12b constitute the second-speed gear stage 12, the third-speed drive gear 13a and idler gear 13b constitute the third-speed gear stage 13, the fourth-speed drive gear 14a and idler gear 14b constitute the fourth-speed gear stage 14, the fifth-speed drive gear 15a and idler gear 15b constitute the fifth-speed gear stage 15, and the sixth-speed drive gear 16a and idler gear 16b constitute the sixth-speed gear stage 16.

The odd-numbered gear stages (first-, third-, and fifth-speed gear stages) are grouped as a first group, and the even-numbered gear stages (second-, fourth-, and sixth-speed gear stages) are grouped as a second group, and to the first main shaft 4, drive gears constituting the gear stages of the first group are joined so as to become capable of transmitting rotations, and to the second main shaft 5, the drive gears constituting the gear stages of the second group are joined so as to become capable of transmitting rotations.

The first counter shaft 6 and the second counter shaft 7 are provided with known synchronization mechanisms 30, 31, 32, and 33 consisting of clutch gears and synchronizer sleeves. The synchronization mechanism 30 is disposed between the first-speed and third speed idler gears 11b and 13b, and the synchronization mechanism 31 is disposed between the second-speed and fourth-speed idler gears 12b and 14b. The synchronization mechanism 32 is disposed between the fifth-speed idler gear 15b and the parking gear P, and the synchronization mechanism 33 is disposed between the reverse idler gear 17b and the sixth-speed idler gear 16b.

With the synchronizer sleeves of the synchronization mechanisms, shift fork members 20 to 23 engage. The shift fork members 20 and 21 are installed slidably along the axis of the first counter shaft 6, and the shift fork members 22 and 23 are installed slidably along the axis of the second counter shaft 7.

The dual clutch transmission 1 can selectively engage and disengage (shift) the first-speed idler gear 11b and the third speed idler gear 13b with and from (in and out of) the counter shaft 6 by the shift fork member 20 and selectively engage and disengage (shift) the second-speed idler gear 12b and the fourth-speed idler gear 14b with and from (in and out of) the counter shaft 6 by the shift fork member 21 by sliding these shift fork members 20 to 23 in the axial directions. The dual clutch transmission 1 can selectively engage and disengage (shift) the fifth-speed idler gear 15b with and from (in and out of) the counter shaft 7 by the shift fork member 22 and selectively engage and disengage (shift) the sixth-speed idler gear 16 and the reverse idler gear 17b with and from (in and out of) the counter shaft 7 by the shift fork member 23.

“Can engage with (shift into) and disengage from (shift out of)” here means that the shifting-in operation to join each idler gear to the counter shaft synchronously rotatably and the shifting-out operation to cancel the synchronous rotation are possible.

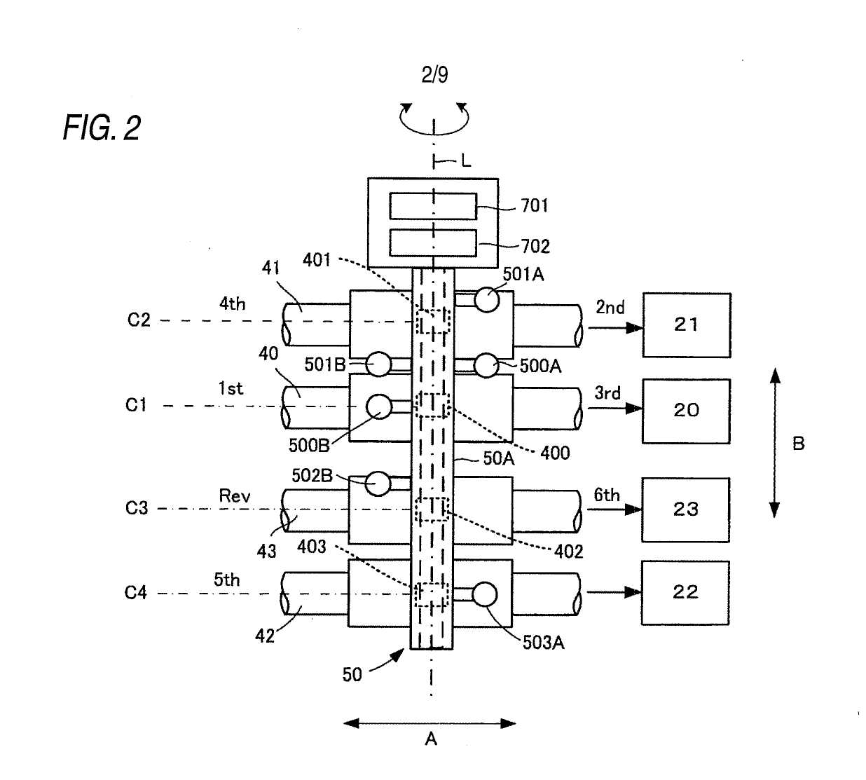

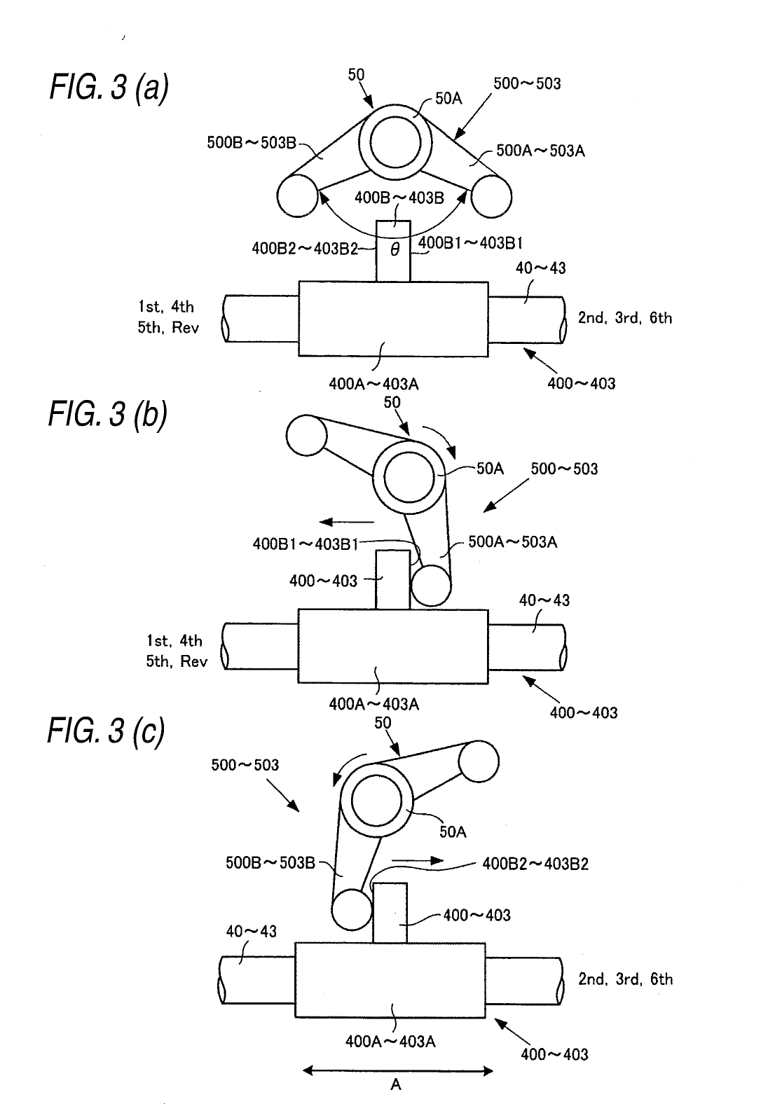

The dual clutch transmission 1 includes, as shown in FIG. 2, a plurality of shift rail members 40, 41, 42, and 43 which perform shifting operations so as to engage and disengage (shifting-in/out) the respective forward gear stages by moving in the shift direction (gear shifting direction) shown by the arrow A, and a shift select member 50 provided movably in the select direction B orthogonal to the shift direction A. As shown in FIG. 1, the shift fork member 30 is fitted to the shift rail member 40 and the shift fork member 31 is fitted to the shift rail member 41 so as to be interlocked with each other, and the shift fork member 32 is fitted to the shift rail member 42 and the shift fork member 33 is fitted to the shift rail member 43 so as to be interlocked with each other. The shift rail members 40 to 43 are provided with a plurality of shift lug portions 400, 401, 402, and 403 projecting outward from the surfaces of the shift rail members, respectively, as shown in FIG. 2, FIG. 3(a), FIG. 3(b), and FIG. 3(c). The shift rail member 40 is provided with the shift lug portion 400, the shift rail member 41 is provided with the shift lug portion 401, the shift rail member 42 is provided with the shift lug portion 402, and the shift rail member 43 is provided with the shift lug portion 403.

The shift lug portions 400 to 403 are formed of, as shown in FIG. 3(a), basal portions 400A to 403A fitted to the shift rail members 40 to 43, and columnar portions 400B to 403B projecting outward from the basal portions 400A to 403A. One-side surfaces 400B1 to 403B1 and the other-side portions 400B2 to 403B2 of the columnar portions 400B to 403B are disposed so as to face the shift direction A.

The shift select member 50 has a swing shaft portion 50A which is disposed so that the axis L thereof is positioned in the select direction B, and supported swingably around the axis L. On the shift select member 50, a plurality of arm portions 500A to 503A and 500B to 503B which are movable in the select direction B and become movable in the shift direction A according to swing of the swing shaft portion 50A around the axis L are provided on the swing shaft portion 50A. The shift select member 50 is configured to move the arm portions 500A to 503A and 500B to 503B in the select direction B to selectively occupy the operation positions C1 to C4 so as to move the shift rail members 40, 41, 42, and 43 which operate the target gear stages so that the arm portions 500A to 503A and 500B to 503B are shifted in the shift direction A when the first drive means 701 shown in FIG. 2 is actuated. The operation position C1 is for operating the shift rail member 40, and the operation position C2 is for operating the shift rail member 41. The operation position C3 is for operating the shift rail member 42, and the operation position C4 is for operating the shift rail member 43.

The plurality of arm portions 500A to 503A and 500B to 503B press the side surfaces 400B1 to 403B1 and the side portions 400B2 to 403B2 of the shift lug portions 400 to 403 to move these in the shift direction A1, are provided so as to project outward from the surface of the swing shaft portion 50A as the surface of the shift select member 50. The arm portions are provided on the shift select member 50 (swing shaft portion 50A) so as to correspond to the shift lug portions.

In the present embodiment, the arm portions project from the shift select member 50 (swing shaft portion 50A) while being forked at an opposing angle θ so as to allow the shift lug portion to be disposed between the forked arm portions, and are opposed to the side surfaces 400B1 to 403B1 and side surfaces 400B2 to 403B2 of the shift lug portions, and are configured to selectively press the side surfaces 400B1 to 403B1 and side surfaces 400B2 to 403B2 facing the shift direction of the shift lug portions as shown in FIG. 3(b) and FIG. 3(c). FIG. 3(a) shows a neutral position in the shift direction of the shift select member 50, and in this case, the arm portions 500A to 503A and 500B to 503B are separated from the shift lug portions 400 to 403. The opposing angle θ of each arm portion is set so as to allow the arm portion to move in the select direction B without interference with each shift lug portion at an appropriate shift position. In the respective arm portions, the sides to press the side surfaces 400B1 to 403B1 are arm portions 500A to 503A, and the sides to press the side surfaces 400B2 to 403B2 are arm portions 500B to 503B.

When the second drive means 702 is actuated, the swing shaft portion 50A of the shift select member 50 swings in the shift direction A at the respective operation positions, presses the shift lug portions opposed to the respective arm portions in the shift direction A, and moves the respective shift rail members in the shift direction A to perform a shifting operation.

In the present embodiment, as shown in FIG. 2, the shift lug portions 400 to 403 are positioned on the axis L of the shift select member 50 when they are not in a gear engaged state but are in an initial state (neutral state), and when a shifting operation is performed, the shift lug portions occupy the right or left positions with respect to the axis L in the figure according to a target forward gear stage. Here, the shifting operation includes a shifting-in operation for joining each idler gear of each gear stage to the counter shaft synchronously rotatably, and a shifting-out operation for canceling the synchronous rotation.

In the present embodiment, arm portion pressing directions when shifting-in a higher forward gear stage next higher than and a lower forward gear stage next lower than a predetermined forward gear stage (of second to fifth gear stages) other than the highest stage and the lowest stage among the plurality of forward gear stages are opposite to each other. In the present embodiment, the relationship between the higher forward gear stage next higher than and the lower forward gear stage next lower than the forward gear stage being currently used for traveling is as shown in Table 1. No gear stage is lower than the first-speed gear stage, and no gear stage is higher than the sixth-speed gear stage, so that the relationship is not applied to these gear stages.

TABLE 1

| Forward gear stage | | |
|---|---|---|
| being used for | | |
| traveling | Next lower forward | Next higher forward |
| (predetermined | gear stage (lower | gear stage (higher |
| forward gear stage) | forward gear stage) | forward gear stage) |
| First-speed gear | | Second-speed gear |
| stage (1st) 11 | | stage (2nd) |
| Second-speed gear | First-speed gear | Third-speed gear |
| stage (2nd) 12 | stage (1st) | stage (3rd) |
| Third-speed gear | Second-speed gear | Fourth-speed gear |
| stage (3rd) 13 | stage (2nd) | stage (4th) |
| Fourth-speed gear | Third-speed gear | Fifth-speed gear |
| stage (4th) 14 | stage (3rd) | stage (5th) |
| Fifth-speed gear | Fourth-speed gear | Sixth-speed gear |
| stage (5th) 15 | stage (4th) | stage (6th) |
| Sixth-speed gear | Fifth-speed gear | |
| stage (6th) 16 | stage (5th) | |

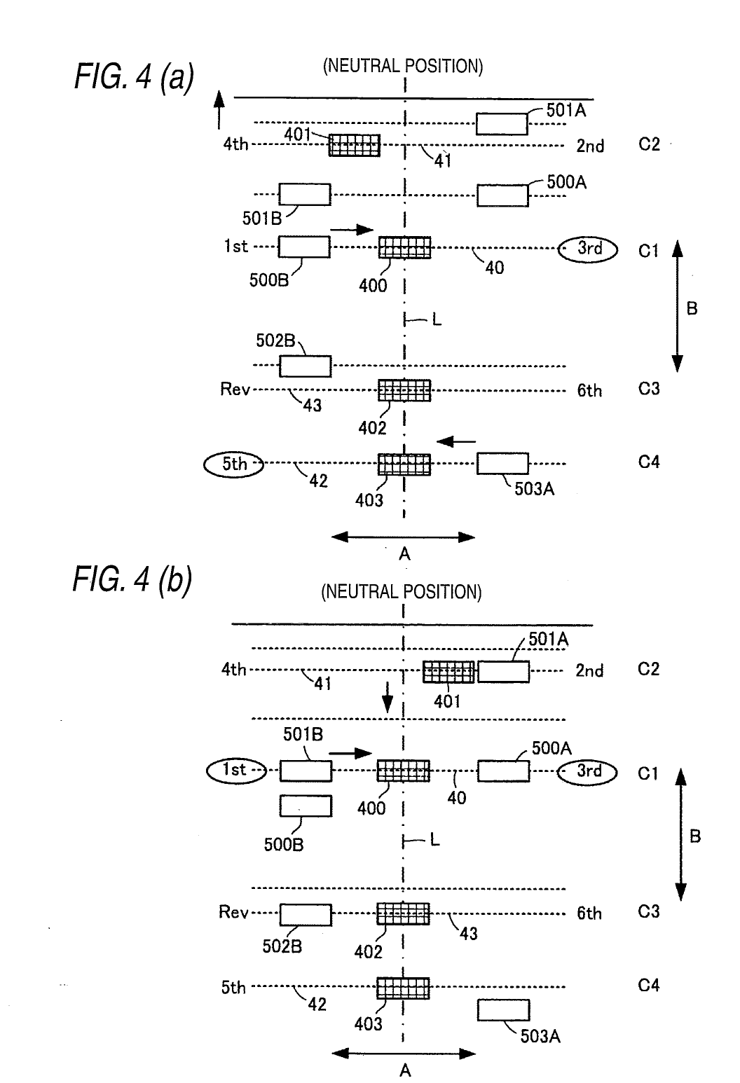

The shift lug portions and the arm portions corresponding to the next lower forward gear stage and the next higher forward gear stage are disposed so as to occupy positions opposed to each other, simultaneously. For example, as shown in FIG. 4(a), when the forward gear stage being used for traveling is the fourth-speed gear stage 14, the next lower forward gear stage is the third-speed gear stage 13 and the next higher forward gear stage is the fifth-speed gear stage 15, and for enabling shifting to both of these forward gear stages, the arm portions are disposed so that the arm portion 500B is opposed to the shift lug portion 400 and the arm portion 503A is opposed to the shift lug portion 403 when the select position of the shift select member 50 is moved by actuating the first drive means 701. The third-speed gear stage 13 and the fifth-speed gear stage 15 are configured so that their arm portion swing directions for shifting-in operations become opposite to each other with respect to the axis L of the shift select member 50. In this case, the forward gear stages 13 and 15 disposed on the different shift rail members 40 and 43 are switched by the arm portion 500B and the shift lug portion 400 and the arm portion 503A and the shift lug portion 403.

Therefore, when an operation for gear shifting to (shifting-in) the third-speed gear stage 13 is performed, the second drive motor 702 is driven so as to swing the shift select member 50 counterclockwise as shown in FIG. 3(c), and when an operation for gear shifting to (shifting-in) the fifth-speed gear stage 15 is performed, the second drive motor 702 is only driven to swing the shift select member 50 clockwise as shown in FIG. 3(b). Specifically, when a forward gear stage for traveling is selected and takes a pre-select position with respect to the next higher or next lower forward gear stage, by moving the shift select member 50 to an operation position by actuating the first drive means 701, the shift select member can take an operation standby position for waiting for operations to the two forward gear stages. Therefore, in a state in which one of the plurality of forward gear stages 13 and 15 positioned on different shift rail members 40 and 43 is determined as an expected gear stage and a pre-select state for the forward gear stage is established, even if a gear shifting (shifting-in) operation in an opposite direction is requested, it is not necessary to move the shift select member 50 in the select direction B for selecting the opposite forward gear stage. Therefore, only by rotating forward or reversely the swing direction of the shift select member 50 (swing shaft portion 50A) by the second drive means 702, a gear shifting operation (shifting-in operation) can be performed, so that when a gear shifting command for either shifting up or shifting down is input, the gear shifting operation can be quickly performed. Even when gear shifting to (shifting-in) the forward gear stage opposite to the estimated gear stage is performed, different from the related art, it is not necessary to move the shift select member 50 in the select direction B, so that the actuation frequency of the first drive means 701 is reduced and gear shifting is performed with low noise, and the durability of the device is improved.

On the other hand, as shown in FIG. 4(b), when the forward gear stage being used for traveling is the second-speed gear stage 12, the next lower forward gear stage is the first-speed gear stage 11, and the next higher forward gear stage is the third-speed gear stage 13. In the present embodiment, gear shifting to either of these two forward gear stages 11 and 13 is possible by operating the same shift rail member 40, so that by moving the shift select member 50 to a select position for the shift rail member 40 by actuating the first drive means 701, the arm portions 500A and 501B are opposed to the shift lug portion 400. The first-speed gear stage 11 and the third-speed gear stage 13 are disposed on the sides opposite to each other with respect to the axis L of the shift select member 50, so that their arm portion swing directions (movement directions) for shifting-in operations are opposite to each other. Therefore, for gear shifting to the first-speed gear stage 11, the second drive motor 702 is actuated to swing the shift select member 50 clockwise in FIG. 3(b), and when gear shifting to the third-speed gear stage 13, the second drive motor 702 is actuated to swing the shift select member 50 counterclockwise in FIG. 3(c). Specifically, when a predetermined forward gear stage is selected and takes a pre-select position with respect to the next higher or next lower forward gear stage, by moving the shift select member 50 to one operation position by actuating the first drive means 701, it can be set at the operation position for the two forward gear stages. Therefore, in a state in which one of the plurality of forward gear stages 11 and 13 positioned on the same shift rail member 40 is determined as an estimated gear stage a pre-select state for the gear stage is established, even if a gear shifting operation (shifting-in operation) in the opposite direction is requested, it is not necessary to move the shift select member 50 in the select direction B for selecting the opposite forward gear stage. Therefore, only by rotating forward or reversely the swing direction of the shift select member 50 by the second drive means 702, a gear shifting operation (shifting-in operation) can be performed, so that when a gear shifting command for either shifting up or shifting down is input, the gear shifting operation can be quickly performed. Even in the case where the gear shifting to the forward gear stage opposite to the estimated gear stage is performed, different from the related art, it is not necessary to move the shift select member 50 in the select direction B, so that the actuation frequency of the first drive means 701 is reduced and gear shifting can be performed with low noise, and the durability of the device is improved.

Thus, in the present embodiment, all forward gear stages except for the highest gear stage and the lowest gear stage, including the configuration in which the higher forward gear stage and the lower forward gear stage are operated for gear shifting (shifting-in) on different shift rail members and the configuration in which the higher and lower gear stages are operated for gear shifting (shifting-in) on the same shift rail member, are configured so that the movement directions of the arm portions for gear shifting to (shifting-in) the higher forward gear stage and the lower forward gear stage become opposite to each other as shown in FIG. 4(a) and FIG. 4(b).

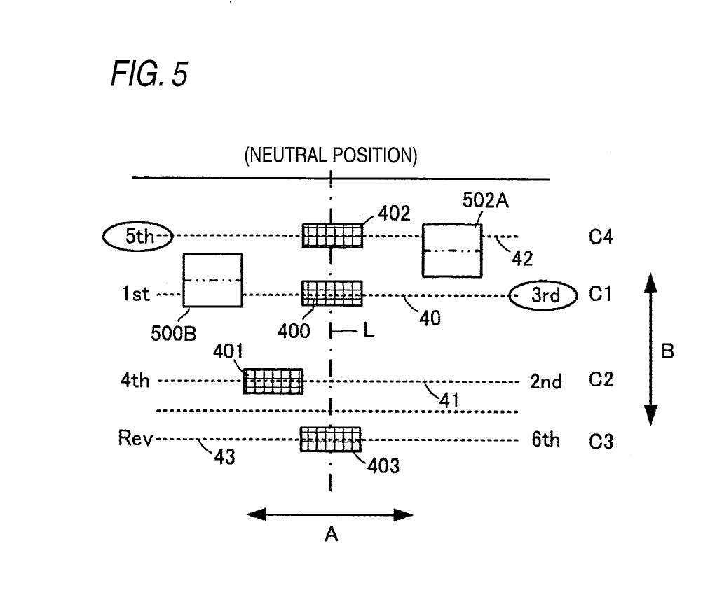

For realizing the position relationship between the arm portions and shift lug portions, for example, in the case where one shift lug portion is provided on one shift rail portion, as shown in FIG. 4(a) and FIG. 4(b), an arm portion which operates a shift lug portion on the same shift rail member and an arm portion which operates a shift lug portion on a different shift rail member are individually provided on the shift select member 50. Alternatively, as shown in FIG. 5, the widths in the select direction B of the arm portions of the shift select member 50 are made longer so that one arm portions have a function to operate a shift lug portion on the same shift rail member and a function to operate a shift lug portion on an adjacent different shift rail member.

In the present embodiment, by adjusting the number and widths of the arm portions, the shift lug portion and the arm portion on different shift rail members are opposed to each other, however, it is also possible that the relationship between the shift lug portion and the arm portion is inverted and the number and widths to the select direction B of shift lug portions are increased so that the shift lug portion and the arm portion on different shift rail members are opposed to each other. Further, it is also possible that the tip end of the shift lug portion is formed to have a pair of claws and a shifting operation is performed by inserting the arm portion between the claws and moving it in the shift direction.

### Second Embodiment

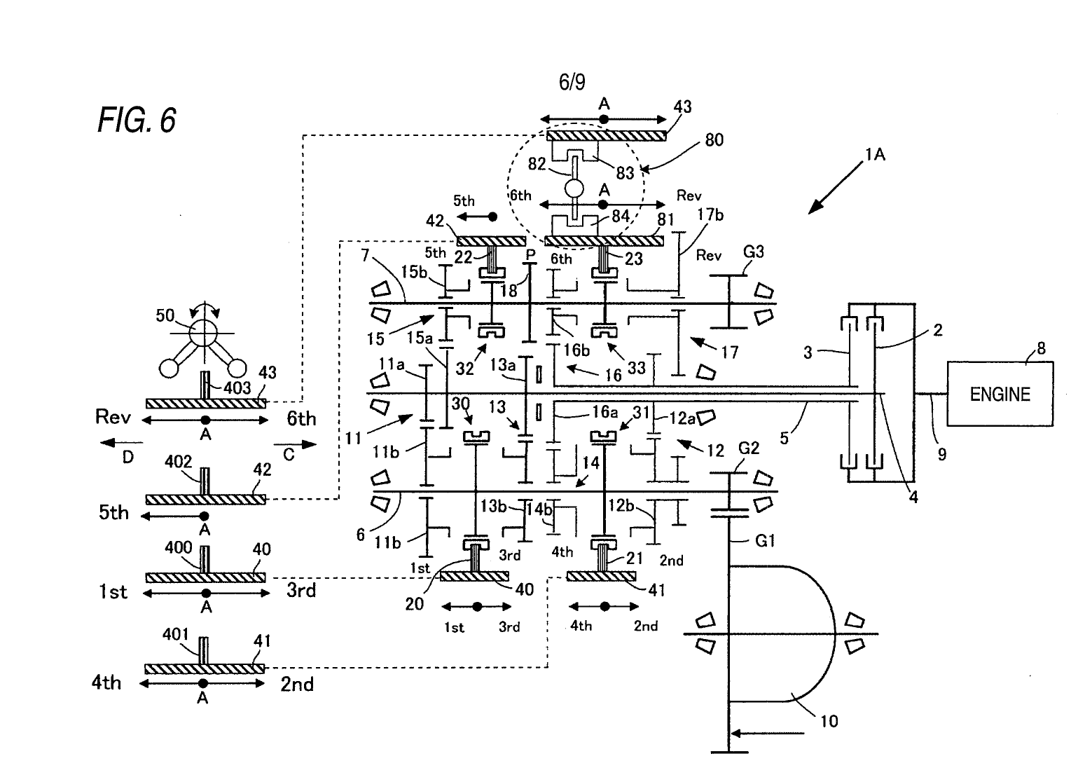

The dual clutch transmission 1A shown in FIG. 6 adopts basically the same configuration as that of the dual clutch transmission 1 shown in FIG. 1, so that the component having the same function as in the configuration shown in FIG. 1 is designated by the same reference numeral as that used in FIG. 1, and detailed description thereof will be omitted.

In the dual clutch transmission 1A shown in FIG. 6, the positions of the sixth-speed idler gear 16b and the reverse idler gear 17b are set oppositely to those in the dual clutch transmission 1 shown in FIG. 1. Specifically, in this dual clutch transmission 1A, arm portion movement directions when gear shifting to (shifting-in) a higher forward gear stage next higher than and a lower forward gear stage next lower than an arbitrary traveling gear stage to be used for traveling among the plurality of traveling gear stages are opposite to each other with respect to the swing axis L of the shift select member 50 as in FIG. 1, however, a gear shifting (shifting-in) operation to the higher forward gear stage cannot be performed in some cases unless the movement direction of the shift rail member and the shift fork member for the higher forward gear stage when performing a gear shifting operation (shifting-in operation) is inverted. For example, when traveling with the fifth-speed gear stage 15 as an arbitrary forward gear stage, the next lower forward gear stage is the fourth-speed gear stage 14 and the next higher forward gear stage is the sixth-speed gear stage 16. These gear stages are operated by different shift rail members 41 and 43, and the swing directions of the shift select member 50 for shifting to these are opposite to each other.

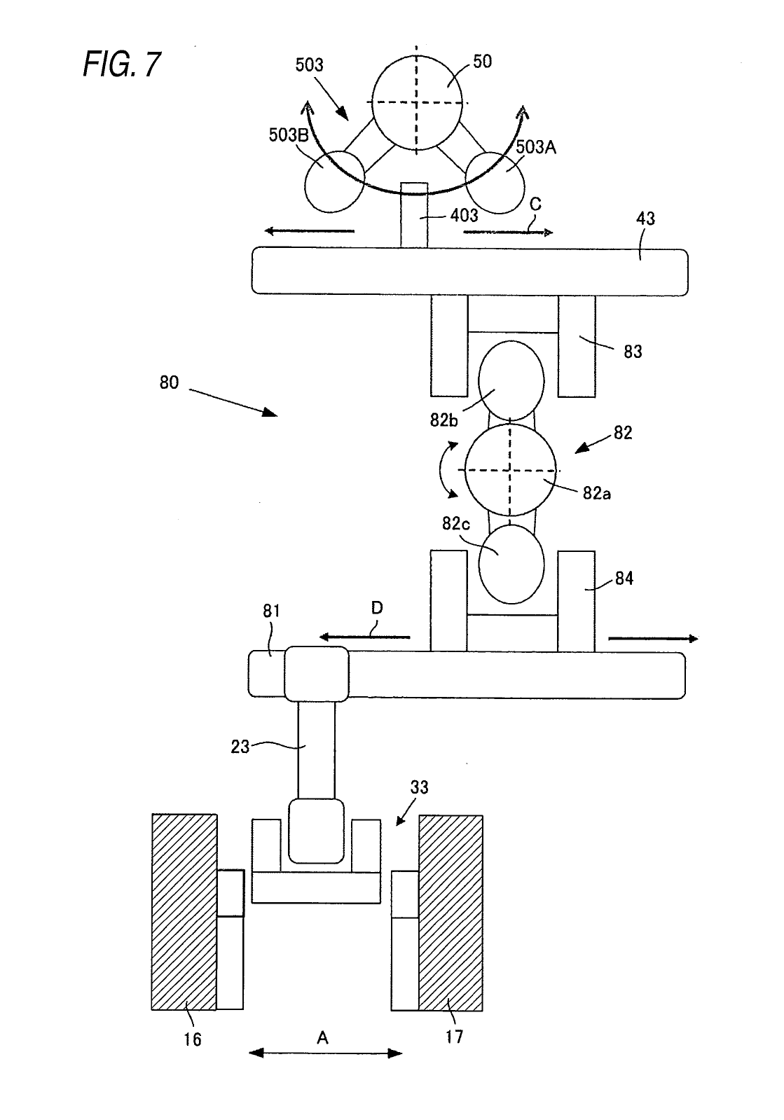

Therefore, in the present embodiment, inverting means 80 which inverts the actuation direction of the shift fork member interlocked with the shift rail member having the selected shift lug portion for the higher forward gear stage (sixth-speed gear stage 16) is provided. The inverting means 80 includes, as shown in FIG. 7, an inverting rail member 81 which is opposed to the shift rail member 43 and supported movably in the shift direction A, and a joint arm member 82 which transmits the movement of the inverting rail member 81 to the shift rail member 43. The inverting rail member 81 is parallel to the shift rail member 43 as an arbitrary shift rail member, and is disposed between the sixth-speed gear stage 16 and the reverse gear stage 17. To the inverting rail member 81, a shift fork member 23 which engages with a synchronizer sleeve of the synchronization means 33 is fitted. That is, the shift fork member 23 is fitted so as to be interlocked with the shift rail member 43 via the inverting means.

The joint arm member 82 has both ends 82b and 82c engaging with the shift rail member 43 and the inverting rail member 81, and is rotatable in the shift direction A around the shaft portion 82a positioned between both ends. The shaft portion 82a is supported by a case not shown. At positions opposite to each other on the shift rail member 43 and the inverting rail member 81, recesses 83 and 84 into which both ends 82b and 82c of the joint arm member 82 are inserted are formed.

In the dual clutch transmission 1A shown in FIG. 6, when a gear shift signal is input for performing a gear shifting operation (shifting-in operation) to the sixth-speed gear stage 16 and the shift rail member 43 is operated in the arm portion swing direction (rightward in the figure) shown by the reference symbol C by the arm portion of the shift select member 50, the end portion 82b of the joint arm member 82 is moved in the gear shift direction C by the recess 83 and the joint arm member 82 rotates clockwise around the shaft portion 82a. Then, the recess 84 of the inverting rail member 81 is moved in the sixth-speed gear shifting direction (leftward in the figure) shown by the arrow D opposite to the arm portion swing direction C by the end portion 82c of the joint arm member 82. According to this movement, the inverting rail member 81 moves to the opposite side of the shift rail member 43 and moves the shift fork member 23 in the sixth-speed gear shifting direction D for gear shifting to (shifting-in) the sixth-speed gear stage 16. That is, the actuation direction of the shift fork member interlocked with the shift rail member having the selected shift lug portion is inverted.

When the inverting means 80 is thus provided, in the relationship of the gear stage alignment, when gear shifting to (shifting-in) the next higher and next lower forward gear stages of an arbitrary forward gear stage is performed, even when the swing direction of the arm portion and the movement direction of the shift fork member are opposite, by inverting the actuation direction of the shift fork member interlocked with the shift rail member with respect to the movement direction of the arm portion by the inverting means 80, different from the related art, it becomes unnecessary to move the shift select member 50 in the select direction B for selecting the forward gear stage opposite to the estimated gear stage, and when a gear shifting command for either shifting up or shifting down is input, a gear shifting operation can be quickly performed with low noise, and the actuation of the drive motor 701 is reduced, so that the durability of the device is improved. Therefore, the alignment of the gear stages is not limited, and the degree of freedom of design is increased.

In the present embodiment, the inverting means 80 is interposed in the gear shifting portion for the sixth-speed gear stage 16, and as a matter of course, it can also be applied to a gear shifting portion for another forward gear stage, and the application of the inverting means is not limited to the present embodiment.

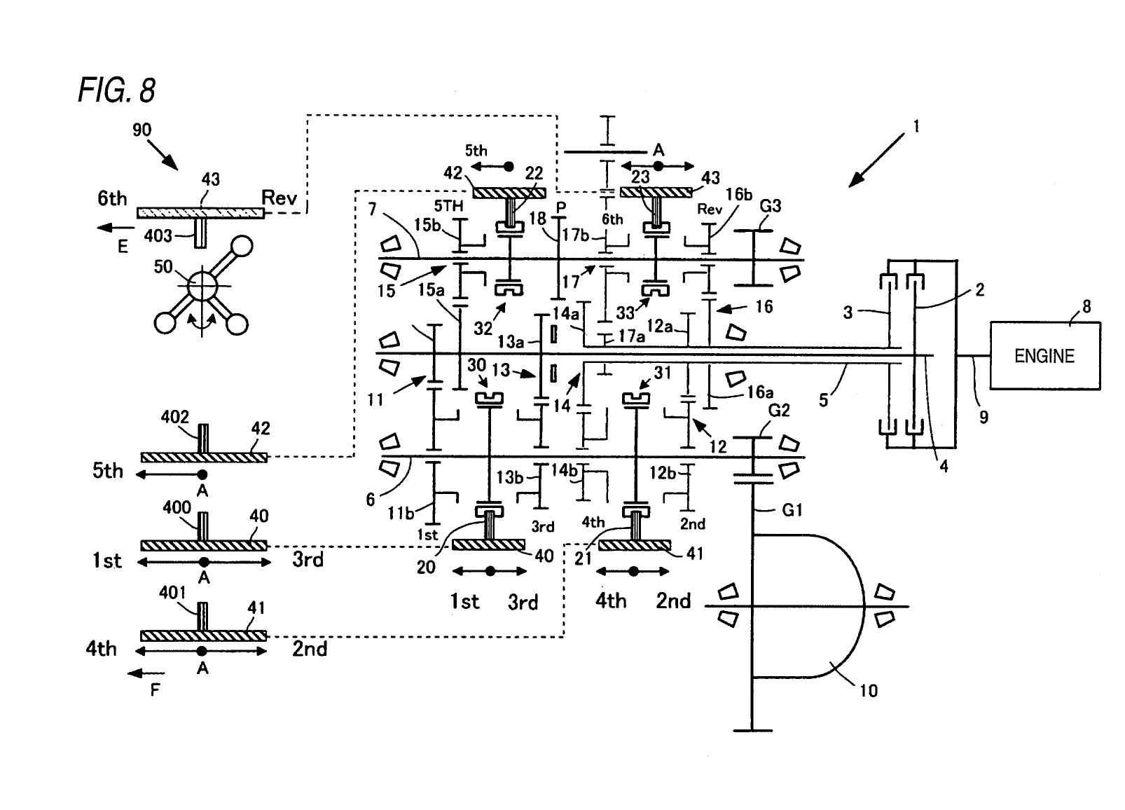

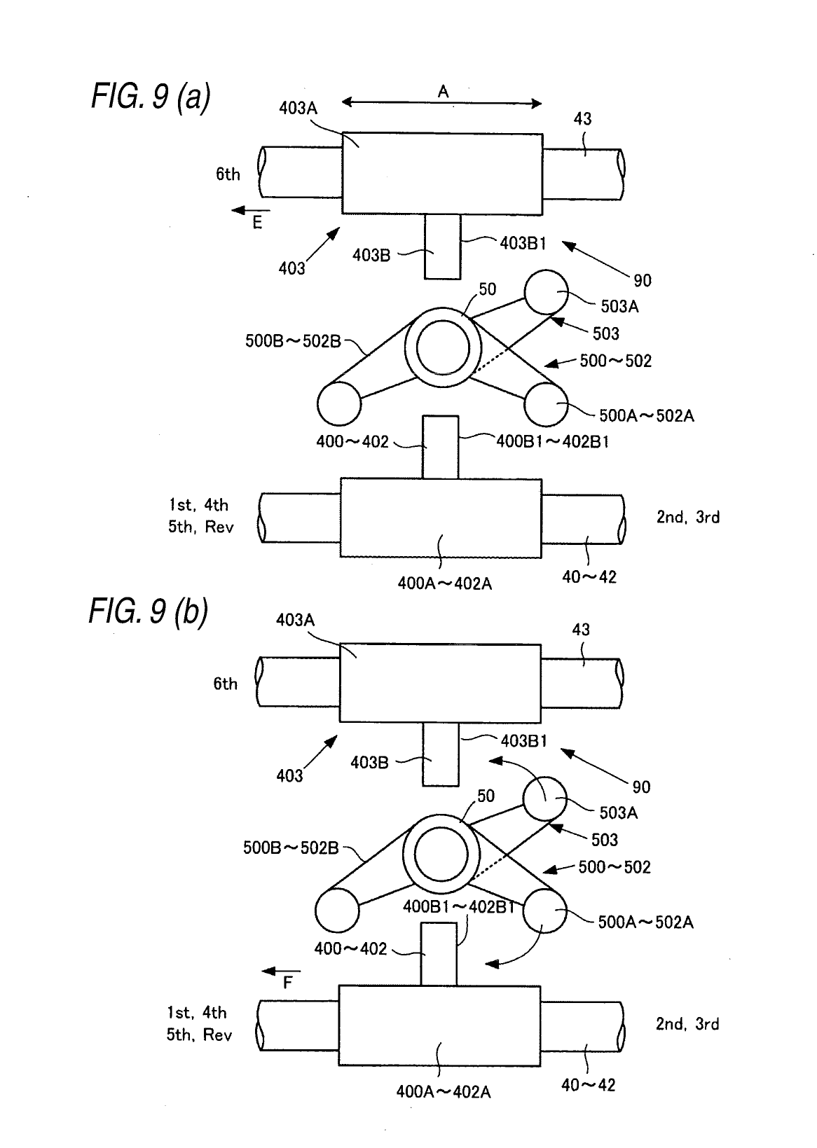

FIG. 8 shows an embodiment in which, in the alignment relationship of the gear stages, in the case where the shift rail member movement directions when gear shifting to (shifting-in) the next higher and next lower forward gear stages of an arbitrary forward gear stage become the same direction, the movement directions of the arm portions which perform operations for shifting-in the higher forward gear stage and the lower forward gear stage are made opposite to each other by a simple configuration without using the above-described inverting means 80. As shown in FIG. 8, in the alignment relationship of the gear stages, when the sixth-speed gear stage 16 is disposed in the same direction as the fourth-speed gear stage 14, the shift rail member 43 as an arbitrary shift rail member may be disposed on the side opposite to other shift rail members 40 to 42 across the shift select member 50 as shown in FIG. 9(a) and FIG. 9(b). This configuration of the inverted disposition serves as inverting means 90.

By thus disposing the shift rail member 43 for gear shifting in and out of the sixth-speed gear stage 16 oppositely to other shift rail members 40 to 42 across the shift select member 50, even when the arm portion swing directions for gear shifting to (shifting-in) the sixth-speed gear stage 16 and the fourth-speed gear stage 14 are set in the same gear shifting direction with respect to the shift select member 50, to perform gear shifting to the sixth-speed gear stage 16, by swinging the shift select member 50 counterclockwise in FIG. 9(a) and FIG. 9(b), the side surface 403B1 of the shift lug portion 403 can be pressed in the sixth-speed gear shifting direction E by the arm portion 503A. To perform gear shifting to the fourth-speed gear stage 14, by swinging the shift select member 50 clockwise in FIG. 9(a) and FIG. 9(b), for example, the side surface 401B1 of the shift lug portion 401 can be pressed in the fourth-speed gear shifting direction F by the arm portion 501A. That is, the swing direction of the shift select member 50 when gear shifting becomes opposite. Therefore, different from the related art, it becomes unnecessary to move the shift select member 50 in the select direction B for selecting a gear stage opposite to an estimated gear stage, and a gear shifting operation can be quickly performed with low noise, and actuation of the drive motor 701 is reduced, so that the durability of the device is improved. Therefore, the alignment of the gear stages is not limited, and the degree of freedom of design is increased.

The aforementioned embodiments are described on the assumption that arm portions are formed on the swing shaft portion 50A of the shift select member 50 and shifting operations are performed by swinging the arm portions 500A to 503A and 500B to 503B, however, the arm portions are not limited to such a swing type, but may be a type which slides in the shift direction A to perform shifting operations.

According to an aspect of the invention, forward gear stages except for the highest gear stage and the lowest gear stage among the plurality of forward gear stages are configured so that the movement direction of the arm portion which performs an operation for shifting-in the higher forward gear stage next higher than a predetermined forward gear stage and the movement direction of the arm portion which performs an operation for shifting-in the lower forward gear stage next lower than the predetermined forward gear stage become opposite to each other, and the arm portions are formed to project so as to select simultaneously the shift lug portions provided on the shift rails corresponding to the higher forward gear stage and the lower forward gear stage when gear shifting to the predetermined forward gear stage, and therefore, different from the related art, in a state in which one of the plurality of gear stages positioned on different shift rail members is determined as an estimated forward gear stage and a pre-select state for the gear is established, even if gear shifting to the opposite gear stage is requested, it becomes unnecessary to move the shift select member in the select direction for selecting the opposite gear stage. Therefore, only by rotating forward or reversely the movement direction (shifting-in operation) of the shift select member, gear shifting can be performed, so that when either gear shift-up or shift-down is commanded, a gear shifting operation can be quickly performed, and even when gear shifting to a gear stage opposite to an expected gear stage is performed, it is not necessary to move the shift select member in the select direction, so that the actuation frequency of the drive source for moving the shift select member is reduced and gear shifting can be performed with low noise, and the shift select member and the drive source thereof are improved in durability.

According to an aspect of the invention, inverting means is provided, so that in the alignment relationship of the gear stages, even when the movement directions of the shift fork members when shifting-in forward gear stages next higher and next lower than an arbitrary gear stage become the same direction, shifting-in these gear stages can be performed only by moving the arm portion formed to project from the shift select member in directions opposite to each other, and therefore, when either shift-up or shift-down is commanded, a gear shifting operation can be quickly performed, and the actuation frequency of the drive source for moving the shift select member is reduced and gear shifting can be performed with low noise, and the shift select member and the drive source thereof are improved in durability.

What is claimed is:

1. A dual clutch transmission in which a plurality of forward gear stages are grouped into first and second groups, first and second main shafts each of which corresponds to the respective one of the first and second groups are provided, and the first and second main shafts are joined to an engine driving force transmission shaft via different clutches, respectively, the dual clutch transmission comprising:
a plurality of shift rail members, each of which has a shift lug portion projecting from a surface thereof, the shift rail members which perform, by actuating shift fork members interlocked by movement of the shift rail members in a shift direction, a shifting-in operation for shifting to a forward gear stage and a shifting-out operation for shifting out of a forward gear stage;
a shift select member which has an arm portion projecting from a surface thereof, the shift select member which, after selecting the shift lug portion of the shift rail member which corresponds to a target forward gear stage by moving the arm portion in a select direction orthogonal to the shift direction, operates the shift rail member having the selected shift lug portion by moving the arm portion in the shift direction to perform the shifting-in operation or the shifting-out operation of the target forward gear stage which corresponds to the shift rail member, wherein
a movement direction of the arm portion for the shifting-in operation of a higher forward gear stage next higher than one of the forward gear stages except for the highest gear stage and the lowest gear stage is opposite to a movement direction of the arm portion for the shifting-in operation of a lower forward gear stage next lower than the one of the forward gear stages, and
the arm portion is formed to project so as to simultaneously select the shift lug portions of the shift rail members which correspond to the higher forward gear stage and the lower forward gear stage when shifting in the one of the forward gear stages.

2. The dual clutch transmission according to claim 1, wherein
the shift lug portion is formed with a columnar portion,
the shift select member is formed with a swing shaft portion which moves the arm portion in the select direction and swings the arm portion in the shift direction, and
the arm portion is moved in the select direction to select the shift lug portion and is swung around an axis of the swing shaft portion:
by applying a pressing force in the shift direction to the columnar portion of the selected shift lug portion from one side surface, to operate the shift rail member having the shift lug portion to perform the shifting-in operation of the forward gear stage which corresponds to the shift rail member; and
by applying a pressing force in the shift direction to the columnar portion of the selected shift lug portion from the other side surface, to operate the shift rail member having the shift lug portion to perform the shifting-out operation of the forward gear stage which corresponds to the shift rail member.

3. The dual clutch transmission according to claim 2, wherein
the arm portion projects so as to be forked at an angle to have arm portions between which the shift lug portion is allowed to be disposed,
the angle is set so as to allow the arm portion to move without interference with each shift lug portion at an arbitrary shift position, and
the arm portion is moved in the select direction to select the shift lug portion and is swung around the axis of the swing shaft portion of the shift select member:
by applying a pressing force in the shift direction from one side surface of the selected shift lug portion by one of the arm portions, to operate the shift rail member having the selected shift lug portion to perform the shifting-in operation of the forward gear stage which corresponds to the shift rail member; and
by applying a pressing force in the shift direction from the other side surface of the selected shift lug portion by the other of the arm portions, to operate the shift rail member having the selected shift lug portion to perform the shifting-out operation of the forward gear stage which corresponds to the shift rail member.

4. The dual clutch transmission according to claim 1, wherein one of the shift rail members and another one of the shift rail members are disposed on the sides opposite to each other across the shift select member, and the shift lug portions of the shift rail members are extended toward the shift select member.

5. The dual clutch transmission according to claim 1, further comprising:
inverting means for inverting an actuation direction of the shift fork member interlocked with the shift rail member having the selected shift lug portion with respect to the movement direction of the arm portion which has selected the shift lug portion.

6. The dual clutch transmission according to claim 5, wherein the inverting means is disposed between one of the shift rail members and the shift fork member, and includes an inverting rail member opposed to the one of the shift rail members and supported movably in the shift direction, and a joint arm member which has both ends engaged with the one of the shift rail members and the inverting rail member and which is rotatable around a shaft portion positioned between the both ends.
